(19) United States
(12) Patent Application Publication
(10) Pub. No.: US 2015/0248273 A1
(43) Pub. Date: Sep. 3, 2015

(54) PROVIDING AUDIO FEEDBACK FOR TOUCH EVENTS

(71) Applicant: TOSHIBA GLOBAL COMMERCE SOLUTIONS HOLDINGS CORPORATION, Tokyo (JP)

(72) Inventors: David John STEINER, Raleigh, NC (US); John David LANDERS, Jr., Raleigh, NC (US); Charles Ray KIRK, Raleigh, NC (US)

(73) Assignee: TOSHIBA GLOBAL COMMERCE SOLUTIONS HOLDINGS CORPORATION, Tokyo (JP)

(21) Appl. No.: 14/194,798

(22) Filed: Mar. 2, 2014

(51) Int. Cl. G06F 3/16; G06F 3/041; G06F 3/0488

(52) U.S. Cl. CPC G06F 3/167; G06F 3/04883; G06F 3/0416; G06F 2203/04808

(57) ABSTRACT

Because a touch controller may not be capable of providing a signal to indicate when to provide audio feedback, a computing system may include a touch event detector that is located in a communication channel between a touch controller and a processing system (e.g., a processor and main memory of a computing system). The touch event detector may monitor the touch data as it is relayed from the touch controller to the processing system via a communication hub. Once the touch event detector identifies a relevant touch event (i.e., a touch event that should provide audio feedback to a user), the touch event detector transmits an instruction to an audio output device (e.g., a speaker) which then generates the audio feedback.

### BACKGROUND

The present invention relates to audio feedback for touch events, and more specifically, to providing a touch event detector in a data communication channel between a touch controller and a processing system.

Touch screens are increasingly being used to supplement or replace more traditional input/output (I/O) devices such as a mouse or keyboard. These traditional I/O devices include different mechanisms for informing the user when a switch is activated. For example, pressing a button on a keyboard provides physical feedback in the form of pressure that indicates to the user that a button was successfully pressed. Also, the buttons on many keyboards inherently produce a sound when pressed that informs the user that a button was activated. Similarly, a mouse button typically emits an audible click when activated by a user. These feedback mechanisms enable a user to quickly determine when a button was activated.

Touch screens, however, do not have physical mechanisms that provide audio or physical feedback for informing the user when the screen has detected user input. For example, capacitive sensing screens detect the presence of an input object (e.g., a human finger or stylus) proximate to the screen by detecting a change in an electrical field. The touch screen includes a touch controller that monitors different electrodes in the screen to determine when a touch event has occurred. To inform the user that a touch event was detected, the touch screen may provide visual feedback to the user. For example, the touch screen may illustrate a graphic of a virtual button being pressed. However, visual feedback requires that a user be constantly viewing the touch screen while audio feedback such as is provided by a keyboard or mouse provide feedback without requiring the user to look at the device.

### SUMMARY

One embodiment of the present disclosure includes a method for outputting a sound associated with a touch event. The method includes receiving, at a communication hub, touch data from a touch controller where the touch data describes user interaction with a touch sensitive region. The method also includes evaluating the touch data at the communication hub to identify a relevant touch event, and upon identifying the relevant touch event, transmitting a signal from the communication hub causing a speaker to output a sound corresponding to the relevant touch event. The method includes forwarding the touch data from the communication hub to a processing system.

Another embodiment described herein is a computer program product for outputting audio feedback where the computer program product includes a computer-readable storage medium having computer-readable program code configured to receive, at a communication hub, touch data from a touch controller where the touch data describes user interaction with a touch sensitive region. The program codes is also configured to evaluate the touch data at the communication hub to identify a relevant touch event, and upon identifying the relevant touch event, transmit a signal from the communication hub causing a speaker to output a sound corresponding to the relevant touch event. The program codes is configured forward the touch data from the communication hub to a processing system.

Another embodiment described herein is an enclosure that includes a communication hub with a first port configured to receive touch data from a touch controller a second port configured to forwarding the touch data to a processing system where the touch data describes user interaction with a touch sensitive region. The enclosure also includes a touch event detector located within the communication hub where the touch event detector is configured to evaluate the touch data to identify a relevant touch event, and upon identifying the relevant touch event, transmit a signal from the communication hub causing a speaker to output a sound corresponding to the relevant touch event.

### BRIEF DESCRIPTION OF THE SEVERAL VIEWS OF THE DRAWINGS

FIG. 1 illustrates placing a touch event detector in a communication channel between a touch controller and processing system, according to one embodiment described herein.

FIGS. 2A-2B illustrate computing systems with communication hubs between a touch controller and processing system, according to embodiments described herein.

FIG. 3 illustrates a method for detecting a touch event and providing audio feedback using the communication hub, according to one embodiment described herein.

FIG. 4 illustrates a computer system for providing audio feedback corresponding to multiple touch screens, according to one embodiment described herein.

FIG. 5 illustrates a computer system with speakers arranged to provide directional audio feedback, according to one embodiment described herein.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

A touch controller may be able to detect multiple types of touch events. In one embodiment, a computing system may provide audio output for certain types of touch events but not others. For instance, a user tapping on the screen may be a touch event (or gesture) that generates audio feedback while dragging a digit across the screen or swiping the digit may be touch events that do not trigger audio feedback.

Many touch controllers do not provide an interface that includes an output for providing audio feedback corresponding to touch events. For example, a touch controller embodied in an integrated circuit may not include an output pin that provides a signal that can be used to provide audio feedback. Nonetheless, a user may prefer receiving audio feedback in addition to, or in lieu of, visual feedback when the touch controller detects a touch event. To provide the audio feedback, a driver may be added to the operating system stack that identifies touch events and provides audio feedback from the user. However, some network administrators may not want to add a driver (or update an existing driver) to enable audio feedback. For example, companies that sell or operate point-of-sale (POS) systems may spend significant time and money to verify that the operating system will work as intended and to ensure that customer information (e.g., personal data, credit card numbers, and the like) is secure. Every change or addition to the operating system of the POS system may require the operating system to be recertified. Thus, updating the operating system so that it provides audio feedback for touch events may be prohibitively expensive or less preferred than a technique to provide audio feedback for touch events where the operating system remains unchanged.

To avoid having the operating system provide audio feedback, a computing system may include a touch event detector that is located in a communication channel between the touch controller and a processing system (e.g., a processor and main memory of a computing system). The touch event detector may monitor (e.g., “sniff”) the touch data transmitted from the touch controller to the processing system. Once the touch event detector identifies a relevant touch event (i.e., a touch event that should provide audio feedback to a user), the touch event detector transmits an instruction to an audio output device (e.g., a speaker) that then generates the audio feedback.

In one embodiment, the touch event detector is located within a communication hub between the touch controller and the processing system. For example, a monitor with a touch screen may include an integrated USB hub that provides data communication between a touch controller in the monitor and the processing system. By locating the touch event detector on the USB hub, the detector can monitor the touch data being transmitted from the touch controller to the processing system and identify the relevant touch events. Alternatively, the communication hub may be added to an already established communication link between the touch controller and the processing system. For example, a user can add the communication hub to the communication channel between the touch controller and the processing system in order to enable the computing system to provide audio feedback.

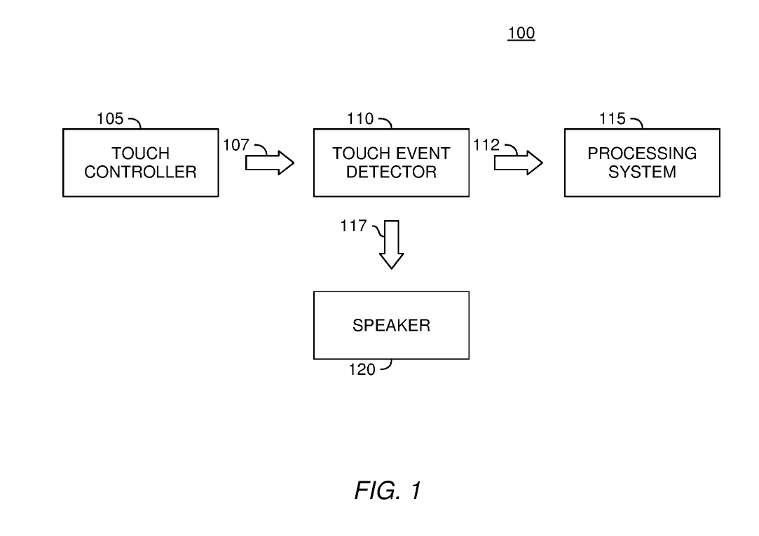

FIG. 1 illustrates placing a touch event detector 110 in a communication channel between a touch controller 105 and processing system 115, according to one embodiment described herein. Flow 100 begins with a touch controller 105 that may include one or more integrated circuits that generate touch data describing user interaction with a touch screen (e.g., a touch sensitive region). The touch screen may either be a dual-purpose screen that is used for both displaying an image to a user and providing a touch sensitive area or only used as a touch sensitive area. Furthermore, the present embodiments discuss a touch controller that uses capacitive sensing for detecting user interaction with the touch screen, but the disclosure is not limited to such. For example, resistive sensing or inductive sensing may also be used to detect user input.

Arrow 107 indicates that the touch controller 105 transmits the touch data to the touch event detector 110. Specifically, the touch event detector 110 is in, or has access to, the communication channel between the touch controller 105 and the processing system 115. As such, the detector 110 is able to monitor the touch data which may include information such as a location of the user input with the screen, duration of the user input, and the like. In one embodiment, the touch data may be encoded in a predetermined format. As will be described in more detail below, the touch event detector 110 may filter the encoded touch data and identify relevant touch events. Stated differently, the touch event detector 110 “sniffs” the touch data (i.e., does not change the touch data as it is transmitted to the processing system) to identify particular coded data that corresponds to one or more relevant touch events. As illustrated by arrow 117, upon identifying a relevant touch event, the detector 110 transmits an instruction (or any kind of suitable signal) that causes a speaker 120 to provide an audio output to the user. The audio output may range from a short beep (less than half a second) to a word or short statement. Although the term “touch event” is used to describe when a touch controller detects user interaction with the touch monitor 105, a touch event may also be generated when the user does not actually touch or make physical contact with the monitor 105. For instance, the user may hover a finger near the touch sensitive region and still generate a touch event.

As shown in FIG. 1, the communication channel between the touch controller 105 and the processing system 115 includes arrows 107 and 112 as well as the touch event detector 110. For example, the touch event detector may be part of a communication hub that receives touch data from the touch controller 105 and then forwards the data to the processing system 115 as shown by arrow 112. Once the touch data is received, the processing system 115 may perform additional computations using the data. For instance, the processing system 115 may convert the touch data into one or more user commands that instruct the processing system 115 to, for example, navigate through windows displayed on the touch monitor, purchase an item, search the Internet, query a database, and the like. In one embodiment, the only way for the touch controller 105 to communicate with the processing system 115 is through the communication hub that includes the touch event detector 110. That is, the communication channel shown in FIG. 1 may be the only communication path between the touch controller 105 and the processing system 115. Furthermore, in one embodiment, the touch event detector 115 may not be located within the operating system of the of the computer system.

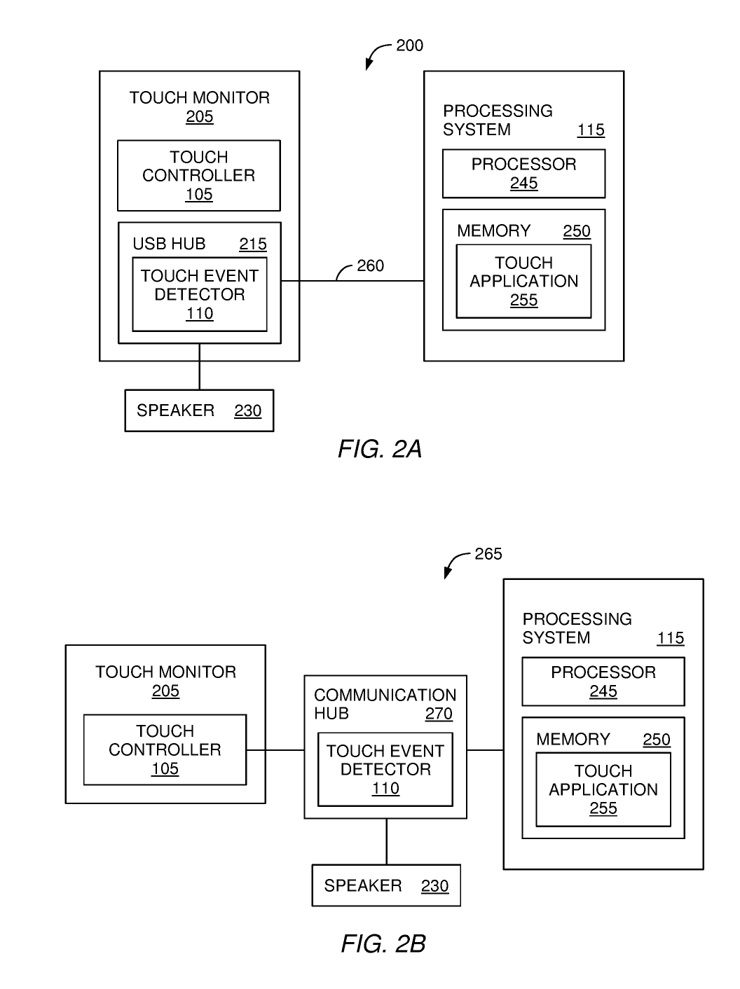

FIGS. 2A-2B illustrate computing systems with communication hubs between a touch controller 105 and processing system 115, according to embodiments described herein. As shown in FIG. 2A, computing system 200 includes a touch monitor 205 and the processing system 115. In one embodiment, the monitor 205 and processing system 115 are included in separate physical enclosures that are communicatively coupled by a communication link 260. For example, the touch monitor 205 may be a computer monitor that include its own mounting structure (e.g., a stand) while the processing system 115 is within a computer tower. Alternatively, the touch monitor 205 and processing system 115 may be integrated into the same physical enclosure such as a laptop, tablet or smartphone. In this scenario, the link 260 may be an internal bus for routing data between components in the physical enclosure.

The touch monitor 205 includes the touch controller 105 and USB hub 215. The touch controller 105 may include one or more integrated circuits tasked with monitoring a touch sensing region on the monitor 205 and detecting user input by, for example, capacitive sensing. In one embodiment, the touch sensing region may be integrated with a display screen of the monitor 205 such that the same area used to display an image to the user is also used as the touch sensing region. As described above, the touch controller 105 detects user input and transmits the touch data to the processing system 115 which interprets the touch data as user commands or instructions.

To facilitate communication between the touch controller 105 and processing system 115, the touch monitor 205 includes the USB hub 215 (e.g., one example of a communication hub) which receives the touch data from controller 105 and forwards the touch data to the processing system 115. As used herein, “a communication hub” is any electronic component that receives data on an input port and forwards the data on an output port. In one embodiment, the hub may include multiple input ports and/or multiple output ports and selection logic for determining how to select which port to route received data.

In FIG. 2A, the link 260 may be a USB cable that communicatively couples the monitor 205 to the processing system 115. Moreover, the USB hub 215 may include multiple ports one of which is connected to a speaker 230. Because the USB hub 215 is integrated within the physical structure of the touch monitor 205, in one embodiment, the ports of the USB hub 215 are exposed on surface of this physical structure so that I/O devices may be coupled to the monitor 205, and thus, be communicatively coupled to the processing system 115. An audio device (e.g., speaker 230), a keyboard, mouse, and the like may be coupled to the ports of the USB hub 215.

The USB hub 215 includes the touch event detector 110 that filters the touch data flowing through the USB hub 215 and identifies relevant touch events as described above. In one embodiment, the touch event detector 110 may be firmware or microcode. However, in other embodiments, the detector 110 may be purely hardware or a mix of hardware and firmware. If the touch event detector 110 is firmware or microcode, then a USB hub 215 that does not already have the ability to monitor the touch data to detect relevant touch events can be updated to include the touch event detector 110. Thus, touch monitors 205 with integrated USB hubs 215 can easily be upgraded to include the touch event detector 110.

Once the touch event detector 110 identifies a relevant touch event, it transmits an instruction to the speaker 230 to output a corresponding sound. Although not shown, the touch event detector 110 may send the instruction to an audio driver or sound card associated with the speaker 230. In response, the speaker 230 outputs the sound which may be a single beep, multiple beeps, a verbal statement, and the like. In one embodiment, the sound may differ depending on the type of touch event was detected. For example, if the user taps the touch monitor 205 once, the touch event detector 110 may instruct the speaker 230 to output a single beep, but if the user taps the monitor 205 twice (i.e., double-taps), the detector 110 instructs the speaker 230 to output two beeps. In this manner, the user is able to hear the audio output and determine what type of input was detected. For example, if the user double-taps but only hears one beep, she can know that the touch controller 105 missed the second tap. In another embodiment, the operating system, instead of the touch event detector 110, characterizes the user interaction as touch event—e.g., a tap or swipe. In this scenario, the touch event detector 110 may be informed of the type of the touch event from the operating system.

Although one speaker 230 is shown, the touch event detector 110 can use any number of speakers 230 to output the audio feedback. Moreover, in one embodiment, the speaker 230 may not be directly connected to the USB hub 215. For example, the speaker 230 may be integrated within the touch monitor 205 or connected to processing system 115. As an example of the latter, the touch event detector 110 may use the link 260 to send instructions to the processing system 115 which then relays those instructions to the speaker 230.

Although an integrated USB hub 215 is shown in FIG. 2A, other types of communication hubs may be integrated into the touch monitor 205 and perform the functions described herein. For example, instead of the USB hub 215, the touch monitor 205 may include a wireless network card or Ethernet card that provides communication with processing system 115. These communication hubs may also include the touch event detector 110 that sniffs the touch data passing through in order to identify relevant touch events.

The processing system 115 includes a processor 245 and memory 250. The processor 245 represents any number of different processors which may have any number of processing elements (e.g., processing cores). Memory 250 may include volatile memory (e.g., DRAM), non-volatile memory (e.g., Flash memory or hard disk drives), or combinations thereof. Memory 250 includes a touch application 255 that receives the touch data from the USB hub 215 and uses processor 245 to execute the user instructions encoded in the touch data. For example, if the user double-taps on a folder icon displayed on the touch monitor 205, in response, the touch application 255 forwards an instruction to an operating system (not shown) to display the contents of the folder on the touch monitor 205. In another example, the touch application 255 may use the touch data to complete a purchase at a store—e.g., the computing system 200 is a point-of-sale (POS) system—or query a database.

FIG. 2B illustrates a computing system 265 where the communication hub 270 that provides communication between the touch controller 105 and processing system 115 is not integrated within the same physical enclosure as the touch monitor 205. For example, the touch monitor 205 may use a communication protocol to transmit the touch data to the processing system 115 that does not require a communication hub such as Serial Peripheral Interface (SPI) or Inter-Integrated Circuit (I²C). Thus, in order to sniff the touch data, a separate communication hub 270 that is compatible with the communication protocol is inserted in the communication channel between the touch controller 105 and the processing system 115. As shown, the communication hub 270 receives the touch data from the touch controller 105 and then forwards the data to the processing system 115. This arrangement enables the touch event detector 110 on the communication hub 270 to evaluate the touch data passing through the hub 270 and identify relevant touch events.

For example, a network administrator may wish to update a computing system to be able to provide audio feedback for a touch monitor. But if the touch monitor does not already have an integrated communication hub (e.g., USB hub 215 in FIG. 2A) which can be upgraded to include the touch event detector 110 (e.g. a firmware update), the administrator can insert the communication hub 270 in the communication channel between the controller 105 and processing system 115. Thus, so long as the communication protocol used to transmit the touch data supports the addition of a communication hub 270, a network administrator can upgrade the computing system to provide audio feedback for touch events.

The communication hub 270 may be a separate physical enclosure or may be integrated into a physical enclosure that includes the processing system 115. For example, the communication hub 270 may be a separate module where a first cable connects the hub 270 to the touch monitor 205 and a second cable couples the hub 270 to the processing system 115. Alternatively, the communication hub 270 may be a network card that can be attached to, for example, an expansion slot in the physical enclosure that includes the processing system 115. In this scenario, the computing system 265 may include a single cable that connects the touch monitor 205 to a port of the network card (i.e., the communication hub 270) that is located in the same physical structure as processing system 115.

Regardless of where the communication hub 270 is located, the hub 270 is communicatively coupled to speaker 230. As shown in FIG. 2B, the speaker 230 is directly connected to the hub 270. However, in other embodiments, the speaker 230 may be coupled to the processing system 115 or may be integrated within monitor 205. In these scenarios, the touch event detector 110 forwards the instruction to output the audio sound corresponding to a relevant touch event to either touch monitor 205 or processing system 115.

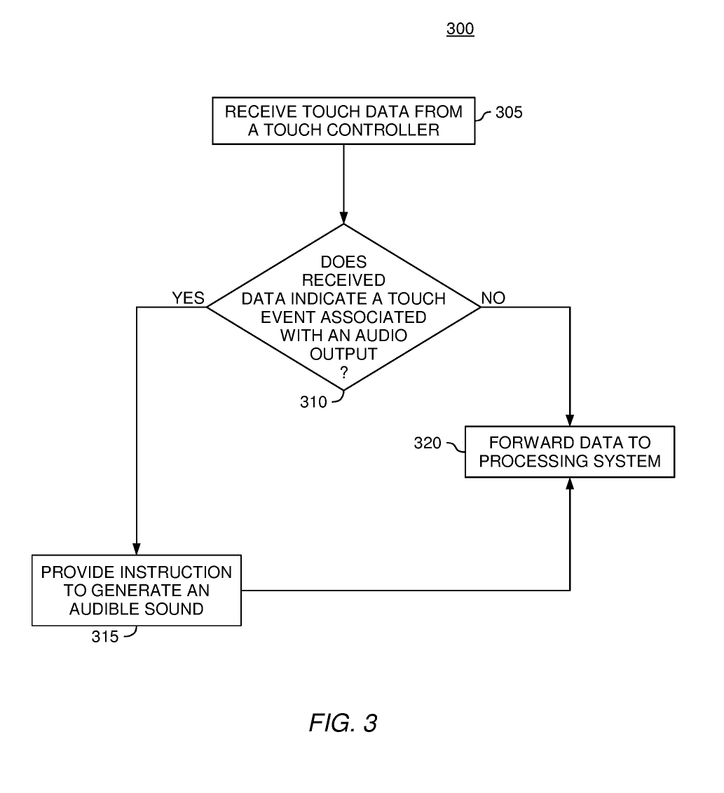

FIG. 3 illustrates a method 300 for detecting a touch event and providing audio feedback using the communication hub, according to one embodiment described herein. At block 305, a communication hub receives touch data from a touch controller. The communication hub may be tasked with forwarding the touch data to a processing system which includes a touch application that converts the touch data into user commands. Stated differently, the communication hub may be an intermediary communication device between the touch controller and processing system. The communication hub is not limited to any particular communication protocol and may use a wireless protocol (e.g., 802.11 protocols) or a wired protocol (e.g., USB, SPI, I²C, and the like).

As the user interacts with a touch sensitive region, the touch controller generates touch data describing the user interaction. In one embodiment, the touch controller generates encoded touch data that a touch application executing on the processing system interprets as user instructions or commands. The different types of user interaction may be encoded differently in the touch data. For example, a single tap with one finger may be represented differently in the touch data than swiping the finger or placing multiple fingers on the touch sensitive region. By assigning different codes to the user interactions, the touch application is able to identify different types of user interaction that can then be interpreted as respective user commands.

At block 310, the touch event detector on the communication hub determines whether the received data indicates a touch event associated with an audio output has occurred. As the touch data flows through the communication hub, the touch event detector filters the data to identify relevant touch events that trigger an audio output. That is, some types of user interactions may trigger audio output while others do not. For example, a single-tap or double-tap may trigger the audio output while swiping one or more fingers does not. As such, in one embodiment, the touch event detector may first evaluate the encoded touch data to determine whether a touch event has occurred. A touch controller may, for example, continuously transmit touch data even if a touch event has not occurred—e.g., the user is not currently interacting with the touch monitor. However, once the user does interact with a touch sensitive region, the touch data may change and include encoded data indicating a touch event has occurred. Once the touch event detector identifies the touch event, the detector may then filter the touch events to determine if it is a relevant touch event. For example, the touch event detector may maintain a data structure that lists the relevant touch event. If a detected touch event does not match an entry in the list (i.e., the touch event is a non-relevant touch event), the touch event detector may not perform any action. The touch data is forwarded to the processing system as shown in block 320 without the touch event detector issuing an instruction to provide audio feedback.

However, if the detected touch event does match an entry in the data structure, at block 315, the touch event detector issues an instruction to the speaker to output the corresponding audio output. As mentioned above, the touch event detector may instruct the speaker to issue a different audio sound depending on the event type of the relevant touch event. However, this is optional and the speaker may output the same audio output even if the relevant touch events are different types of touch events.

In one embodiment, the touch event detector may issue an instruction that specifies the audio output to be provided by the speaker. For example, the touch event detector may instruct the speaker to play one beep if the relevant touch event is a single tap and two beeps if the relevant touch event is two taps. However, in another embodiment, the touch event detector may instead indicate the type of the relevant touch event to the speaker which then decides what audio output to provide. For example, a sound driver or sound card that manages the speaker may receive the instruction from the touch event detector and decide which audio output is appropriate based on the touch event type contained in the instruction.

Once the touch event detector gets a chance to evaluate the received touch data, the communication hub forwards the touch data to the processing system as shown in block 320. In one embodiment, the communication hub may delay the data to provide enough time for the touch event detector to process the touch data and determine if a relevant touch event has occurred. However, in other embodiments, the touch event detector may be able to process the touch data in parallel with the logic within the communication hub that forwards the touch data to the processing system. In this situation, the touch data flows through the communication hub at the same rate regardless of whether the touch event detector is executing on the hub. Furthermore, in one embodiment, the touch event detector does not change the touch data. That is, the touch event detector does not need to change the touch data in order to identify relevant events that trigger audio feedback. Thus, from the perspectives of the touch controller and processing system, a communication hub that includes the touch event detector may function in the same manner as a communication hub that does not include the detector. Stated differently, adding the touch event detector to the communication hub does not have to increase the time needed for the data to reach the processing system or increase the likelihood of data corruption relative to a communication hub that does not include the touch event detector.

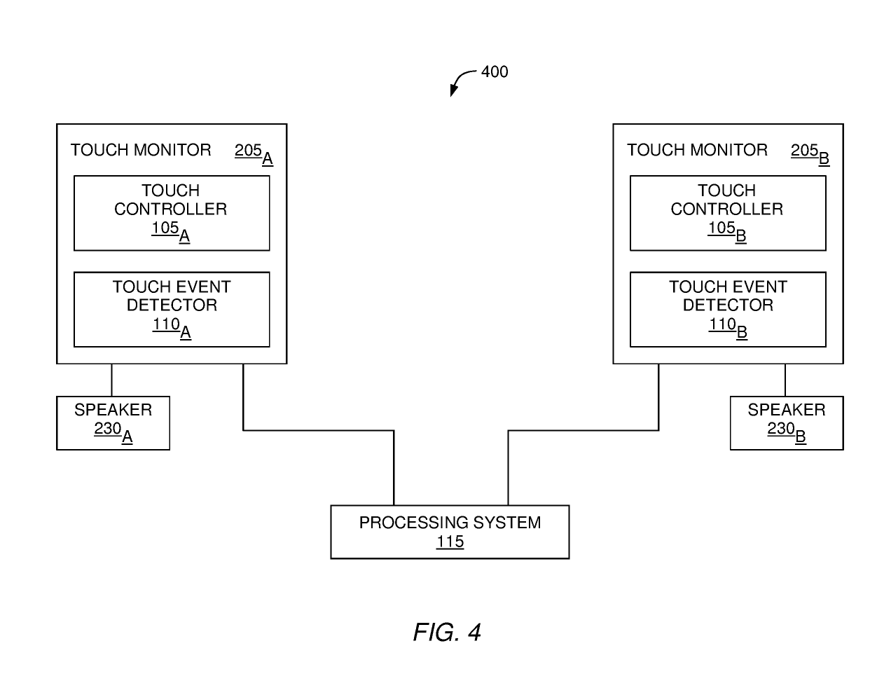

FIG. 4 illustrates a computer system 400 for providing audio feedback corresponding to multiple touch monitors, according to one embodiment described herein. As shown, the processing system 115 is coupled to multiple touch monitors 205 which each include a separate touch controller 105. Although two touch monitors 205 are shown, the system may include any number of monitors 400.

Each touch monitor 205 also includes a touch event detector 110 located within a respective integrated communication hub (not shown). As described above, the touch event detectors 110A and 110B evaluate the touch data flowing between the touch controllers 105 and the processing system 115. If one of the touch event detectors 110 identify a relevant touch event, the detector 110 transmits an instruction to the corresponding speakers 230 to generate the corresponding audio output. The speakers 230A and 230B may be contained within a separate physical enclosure or integrated into the physical enclosure of the monitors 205. Furthermore, the speakers 230A and 230B may be connected to the processing system 115. If so, the touch event detectors 110 may inform the processing system which speaker 230 should output the audio sound. For example, if touch event detector 110B identified a relevant touch event, the detector 110B instructs the processing system 115 to output the sound using speaker 230B instead of speaker 230A. As will be discussed in greater detail below, the speakers may be arranged to output sound in a desired direction to indicate to the user which touch monitor 205 detected the touch event. That is, if multiple users are interacting with the touch monitors 205 simultaneously but the speakers 230A and 230B output sound in the same direction, the users may be unable to tell which touch monitor 205 actually recorded the touch event.

Furthermore, all the functions associated with computer systems that have one touch monitor coupled to a processing system as described in FIGS. 2A-B and 3 above may be applied here. For example, each touch event detector 110 may output a different sound on their respective speaker 230 depending on a type of the relevant touch event. Moreover, instead of having the touch event detectors 110 integrated into the touch monitors 205, the detectors 110 may be located in communication hubs that have separate physical enclosures and are located between the respective monitors 205 and the processing system 115 or the communication hubs may be integrated within the processing system 115.

In one embodiment, multiple touch monitors 205 may use the same communication hub—i.e., a shared communication hub. For example, the touch controllers 105A and 105B may both be connected to the same, shared communication hub. Both touch monitors 205 transmit the touch data to the shared communication hub which then forwards the touch data to the processing system 115. The touch data may have an identifier associated with it so the processing system 115 can differentiate touch data generated by controller 105A from data generated by controller 105B. Alternatively, the shared communication hub may use two different cables to transmit touch data to two different input ports in the processing system 115 where touch data from controller 105A is sent exclusively on one cable and touch data from controller 105B is sent only on the other cable. Furthermore, the shared communication hub may use only one touch event detector 110 to monitor the touch data transmitted by both touch controller 105A and 105B. That is, a single touch event detector 110 evaluates the touch data transmitted by both monitors 205 to identify relevant touch events. If a relevant touch event is identified, the touch event detector 110 may transmit an instruction to the corresponding speaker 230. For example, if the relevant event was found in touch data transmitted by controller 105A, the touch event detector 110 transmits an instruction to speaker 230A to provide the corresponding audio output.

In one embodiment, the computer system 400 may use only one speaker 230 to provide audio feedback rather than assigning a speaker 230 to each of the touch monitors 205. In this example, different sounds may be associated with different touch monitors 205. For example, the touch event detector 110A may instruct the shared speaker 230 to output a single beep whenever a relevant touch event is identified while touch event detector 110B may instruct the shared speaker 230 to output two beeps whenever a relevant touch event is identified. So long as the user knows what the different beeps represent, a single speaker 230 can be used to provide audio feedback for multiple touch monitors 205. Of course, it may be preferred to have a greater variance between the sounds assigned to each of the monitors 205. For example, if a relevant touch event is identified by detector 110A, the shared speaker 230 may output one or more beeps but detector 110B may instruct the shared speaker 230 to output verbal statements.

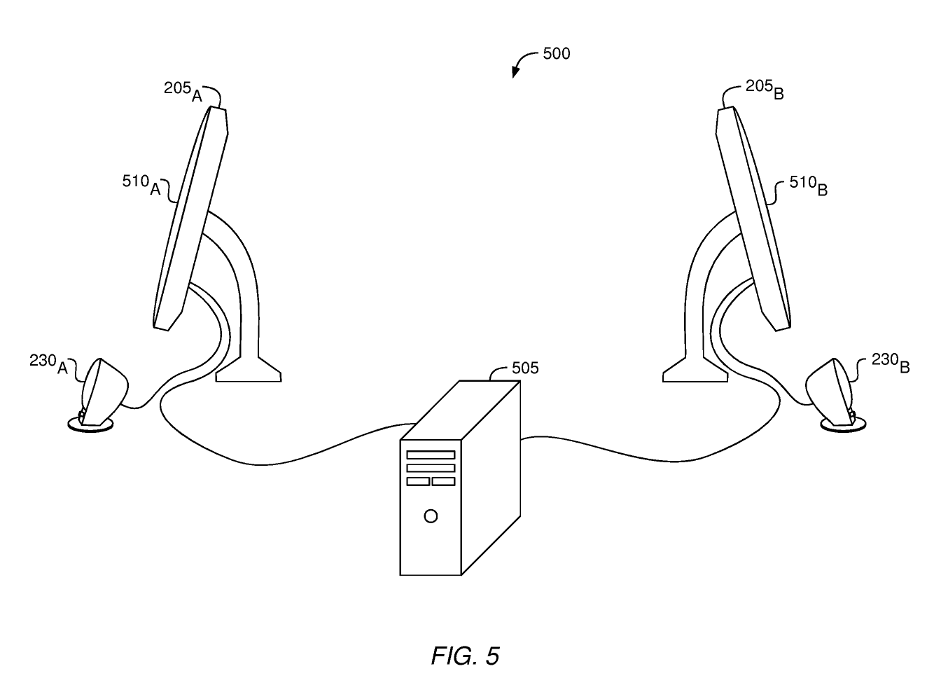

FIG. 5 illustrates a computer system 500 with speakers 230 arranged to provide directional audio feedback, according to one embodiment described herein. As shown, computer system 500 includes two touch monitors 230 with corresponding speakers 230 attached to a physical enclosure 505 that contains a processing system. In this embodiment, it is assumed that each touch monitor 205 contains an integrated communication hub (not shown) with a touch event detector but this is not a requirement.

In one embodiment, the computing system 500 may be a POS system where one monitor is used by the store's cashier (e.g., monitor 205A) while the other monitor is used by the customer (e.g., monitor 205B). Because the cashier and the customer may be separated by a counter or scanning area, the monitors 205 are arranged in different directions to be viewable by the respective users. Although FIG. 5 illustrates the touch monitors 205 being arranged back-to-back, any arrangement is possible—e.g., the screens 510 of the touch monitors 205 may be perpendicular to each other. When scanning items the customer wishes to purchase, the cashier may use touch monitor 205A to enter information (e.g., coupon information or an item's identification number), instruct the POS system to perform an auxiliary function (e.g., weigh an item using a built-in scale), inform the POS system of the customer's payment method (e.g., whether the customer is paying with cash, debit, or credit), and the like. To do so, the cashier uses any number of gestures or actions that are interpreted by the touch controller in the monitor 205A as respective touch events. As described above, these touch events are transmitted to the processing system which performs the user commands associated with these touch events. Because the cashier repeatedly provides these instructions to the system 500, she may be able to interact with the screen 510A without looking at the touch monitor 205A. For example, the cashier may know where to touch the screen 510A to instruct the POS system to weigh an item without looking. If the cashier is not looking at the screen, without audio feedback, the cashier is unable to know whether the POS system received the instructions. However, computer system 500 includes directional speaker 230A which may be pointing at the cashier—e.g., pointing in a direction normal to the plane established by the screen 510A. Stated generally, the speaker 230A may be directed at an area where the user of the monitor 110A is expected to stand or sit. Thus, once a relevant touch event is detected, the touch event detector in touch monitor 205A transmits an instruction to speaker 230A to provide the corresponding audio output. By providing audio output, the cashier is free to look elsewhere. For example, with the left hand the cashier can interact with the screen 510A while looking at the scanning area and using her right hand to move an item onto the scale. The audio feedback lets the cashier know if the left hand successfully inputted the command to the POS system.

While providing audio feedback to the cashier using speaker 230A, touch monitor 205B may provide audio feedback to a customer using directional speaker 230B which may be aligned in a direction normal to the plane established by screen 510B. Because the touch screens 510 do not provide the same physical feedback like other I/O devices, the customer may be unsure whether her instructions were received. For example, because of delays associated with the processing system, the customer may touch the screen 510B but it may take several seconds before the display is updated based on the customer's instruction. During this delay, the customer does not know if the system 500 is busy processing her request or if the touch was not detected by the touch controller in the monitor 205B. However, using the touch event detector, the computing system 500 provides an audio feedback each time a relevant touch event is detected. Thus, even if there is a delay when processing the customer's instructions, the touch event detector can output the audio feedback. Once the customer hears the audio output from speaker 230B, she can know her touch input was accepted and the POS system is processing her request. This may stop the customer from repeatedly performing the same action (e.g., touching the screen 510B repeatedly) which could be interpreted as separate user commands and cause the processing system to perform an unintended function or cause the processing system to malfunction.

The aligned speakers 230 improve the ability of the system 500 to direct the audio feedback to the intended user. For example, if the monitors 205 are being used simultaneously, both speakers 230 may output audio feedback. If the speakers 230 were not aligned with the display screens 510, the users may be unable to determine who the audio output is for—i.e., which touch monitor 205 identified the relevant touch event. In one embodiment, the speakers 230 may be integrated into the touch monitors 205 so that their output faces in the direction normal to the screens 510. Thus, even if the monitors 205 are moved, the speakers 230 will maintain this directional relationship with the screen 510. Although FIG. 5 illustrates aligning the speakers 230 relative to the screens 510, there are different methods of arranging the speakers 230 that still provide directional audio output. For example, the speakers 230 may be mounted above areas where respective users of the touch monitors 205 are likely to stand such that the speakers 230 face down towards the user.

In addition to aligning the speakers 230A and 230B to provide audio feedback in a desired direction, the system 500 may use different audio output schemas for the speakers 230. For example, the speaker 230A facing a cashier may output beeps when relevant touch events are identified while the speaker 230B facing a customer may output spoken prompts. In one embodiment, the different audio feedback schemas use different sounds so that every sound is unique to the particular schema. Doing so may further reduce user confusion and allow the user to quickly determine whether they are the intended recipient of the audio feedback.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A method comprising:
receiving, at a communication hub, touch data from a touch controller, the touch data describing user interaction with a touch sensitive region;
evaluating the touch data at the communication hub to identify a relevant touch event;
upon identifying the relevant touch event, transmitting a signal from the communication hub causing a speaker to output a sound corresponding to the relevant touch event; and
forwarding the touch data from the communication hub to a processing system.

2. The method of claim 1, further comprising:
converting the touch data at the processing system into one or more user commands to be performed by the processing system, wherein the processing system and touch controller communicate only through the communication hub.

3. The method of claim 1, wherein the touch controller is housed in a first physical enclosure different from a second physical enclosure housing the processing system.

4. The method of claim 3, wherein the communication hub is one of (i) housed within the first physical enclosure including the touch controller and (ii) housed within a third physical enclosure separate from the first and second physical enclosures.

5. The method of claim 3, wherein the communication hub is a USB hub housed within the first physical enclosure including the touch controller.

6. The method of claim 1, wherein evaluating the touch data to identify the relevant touch event further comprises:
monitoring the touch data to identify encoded data indicating a plurality of touch events; and
evaluating the plurality of touch events to identify relevant and non-relevant touch events, wherein the non-relevant touch events are not assigned an audible sound and the relevant touch events are assigned audible sounds.

7. The method of claim 6, wherein evaluating the touch data to identify the relevant touch event further comprises:
selecting different audible sounds for output by the speaker based on a type of each of the relevant touch events.

8. A computer program product for outputting audio feedback, the computer program product comprising:
a computer-readable storage medium having computer-readable program code embodied therewith, the computer-readable program code is configured to:
receive, at a communication hub, touch data from a touch controller, the touch data describing user interaction with a touch sensitive region;
evaluate the touch data at the communication hub to identify a relevant touch event;
upon identifying the relevant touch event, transmit a signal from the communication hub causing a speaker to output a sound corresponding to the relevant touch event; and
forward the touch data from the communication hub to a processing system.

9. The computer program product of claim 8, further comprising computer-readable program code configured to convert the touch data at the processing system into one or more user commands to be performed by the processing system, wherein the processing system and touch controller communicate only through the communication hub.

10. The computer program product of claim 8, wherein the touch controller is housed in a first physical enclosure different from a second physical enclosure housing the processing system.

11. The computer program product of claim 10, wherein the communication hub is one of (i) housed within the first physical enclosure including the touch controller and (ii) housed within a third physical enclosure separate from the first and second physical enclosures

12. The computer program product of claim 10, wherein the communication hub is a USB hub housed within the first physical enclosure including the touch controller.

13. The computer program product of claim 8, wherein evaluating the touch data to identify the relevant touch event further comprises computer-readable program code configured to:
monitor the touch data to identify encoded data indicating a plurality of touch events; and
evaluate the plurality of touch events to identify relevant and non-relevant touch events, wherein the non-relevant touch events are not assigned an audible sound and the relevant touch events are assigned audible sounds.

14. The computer program product of claim 13, wherein evaluating the touch data to identify the relevant touch event further comprises computer-readable program code configured to:
select different audible sounds for output by the speaker based on a type of each of the relevant touch events.

15. An enclosure, comprising:
a communication hub with a first port configured to receive touch data from a touch controller and a second port configured to forward the received touch data to a processing system, the touch data describing user interaction with a touch sensitive region; and
a touch event detector located within the communication hub, the touch event detector is configured to:
evaluate the touch data to identify a relevant touch event, and
upon identifying the relevant touch event, transmit a signal from the communication hub causing the speaker to output a sound corresponding to the relevant touch event.

16. The enclosure of claim 15, further comprising the touch controller and the touch sensitive region.

17. The enclosure of claim 16, wherein the enclosure is a touch monitor comprising a display screen integrated with the touch sensitive region.

18. The enclosure of claim 15, wherein the enclosure does not contain the touch controller and the touch sensitive region.

19. The enclosure of claim 15, wherein the communication hub is a USB hub.

20. The enclosure of claim 15, wherein the touch event detector is configured to:
monitor the touch data to identify encoded data indicating a plurality of touch events; and
evaluate the plurality of touch events to identify relevant and non-relevant touch events, wherein the non-relevant touch events are not assigned an audible sound and the relevant touch events are assigned audible sounds.
